(19) United States
(12) Patent Application Publication
(10) Pub. No.: US 2004/0121869 A1
(43) Pub. Date: Jun. 24, 2004

(54) Strip comprising a fabric having a stitched twill weave on both sides

(76) Inventor: Marion Becella, Zurich (CH)

Correspondence Address: David L Principe, Hodgson Russ, Suite 2000, One M & T Plaza, Buffalo, NY, 14203-2391, US

(21) Appl. No.: 10/472,684

(22) PCT Filed: Mar. 21, 2002
(86) PCT No.: PCT/CH02/00169

(30) Foreign Application Priority Data
Apr. 4, 2001 (CH) 633/01

(51) Int. Cl. F16G 1/00; F16G 1/04; F16G 5/00

(52) U.S. Cl. 474/267; 474/260; 474/266

(57) ABSTRACT

A The invention relates to a strip, especially a drive belt, comprises comprising a fabric (G) as a tractional layer, the said fabric having a stitched twill weave on both sides. The inventive strip is such that it remains flexible while at the same time guaranteeing high force transmission. Due to the fact that the fabric has a stitched twill weave on both sides, the two sides thereof can be used.

This invention relates to a belt comprising a woven fabric as traction layer.

The term “belt” is used herein as a collective term for drive belts, conveyor belts and process belts.

The traction layer of a belt, and especially of a drive belt, frequently consists of one or more plies of a thermoplastic synthetic material or of one or more plies of a textile article and especially of a woven fabric. This traction layer is rubber coated.

A traction layer made from thermoplastic synthetic material is made, for example, from an extruded polyamide sheet. Such a traction layer is characterised by high flexural strength and low compressive strength.

The threads of the textile articles and especially of the woven fabrics, can be made from synthetic raw materials, for example from polyamides, aramids, polyesters, polyolefins, etc. However, they can also be made from natural raw materials, for example from cotton, from stalk fibers such as flax or hemp, from wool, from silk etc. Moreover, mineral raw materials such as, for example, glass or carbon are a possibility for use as a raw material for the threads. Lastly, mixtures of all these raw materials come into consideration as well. The woven fabric can be produced from all known types of yarn, such as for example multifilaments, monofilaments, staple fiber yarns or folded or cabled yarns.

The traction layer of the belts, especially of the drive belts, is exposed to enormous stresses in operation. Traction layers composed of thermoplastic synthetic material are not very flexible (see above) and therefore require large rollers or pulleys to guide or deflect them, which entails a comparatively large consumption of drive energy (the mass of the rollers or pulleys has to be driven). In the case of traction layers composed of textile articles, in contrast, flexibility is high but at times the transmission of force is not sufficient, which is why plural such textile traction layers are frequently adhered together. This is disadvantageous in that this requires a further operation in manufacture, namely the adhering together of the textile traction layers. Furthermore, the material requirements increase as a result, since two or more textile traction layers are needed. However, above all, an impairment of the flexibility of the traction layer as a whole results.

This is where this invention seeks to provide a remedy. It is accordingly an object of this invention to propose a belt, and especially a drive belt, that not only permits a large transmission of force, but also remains flexible at the same time.

This object is achieved by the belt characterized by the features of independent claim 1. Particularly advantageous embodiments are established by the features of the dependent claims.

The essence of this invention is that, in a belt which comprises a woven fabric as traction layer, the woven fabric comprises an even-sided plural-wale twill weave.

In the belt of this invention, a belt is provided which permits a large transmission of force while remaining flexible at the same time. The plural-wale twill weave is even-sided (the structure is the same on both sides of the fabric) to ensure that the fabric can be used on both sides; that is, it is immaterial which side of the fabric is up and which is down. Since a plural-wale twill weave contains, as the designation implies, plural types of wales, there are also floats (extended thread portions) of various lengths with tight interlacings between these floats (where a thread passes over or under just one further thread). Longer extended thread portions mean a more direct transmission of the actual force on the thread, since the extended thread is not immediately deflected and interlaced. True, such floating yarn can entail an albeit small reduction in the slip resistance of the fabric, but this reduction is hardly noticeable overall.

If the woven fabric is to be reinforced, it is possible to engineer a further woven ply interlaced with the woven ply having the even-sided plural-wale twill weave. Similarly, the woven fabric can contain conductive threads, which is of advantage when there is a build-up of an electrostatic charge in the belt in operation due to friction. In this case, the electrically conductive thread can dissipate the charge.

Further advantageous embodiments will be apparent from the subsequent description of an illustrative embodiment of the belt of this invention in the form of a drive belt with reference to the drawing, where

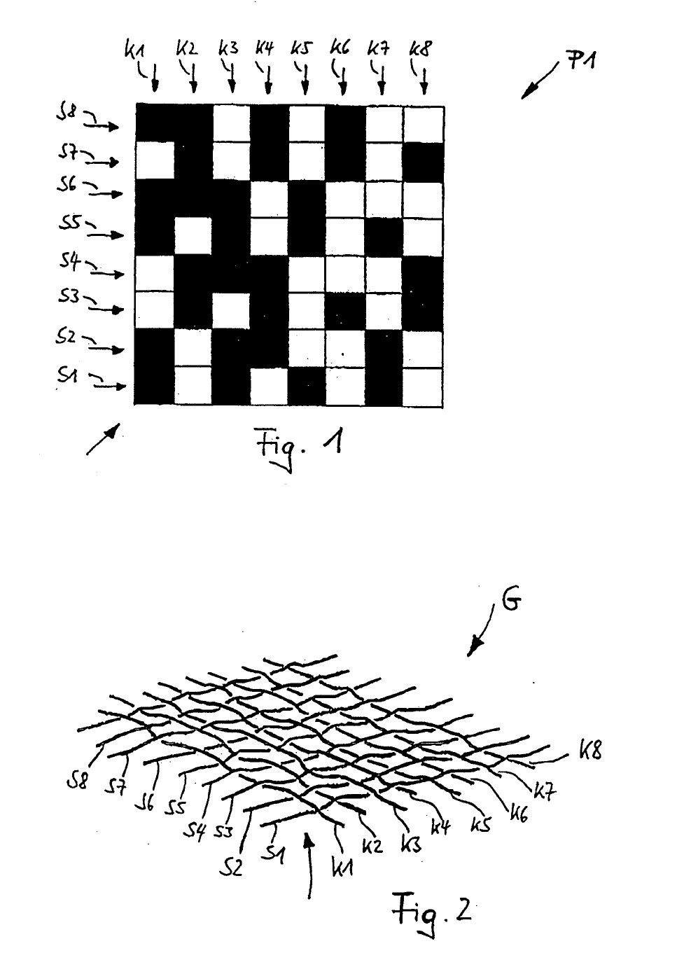

FIG. 1 shows an illustrative embodiment of a weave repeat of the woven fabric of the traction layer of a drive belt according to this invention; and

FIG. 2 shows a less idealized depiction of part of the woven fabric having the weave repeat of FIG. 1.

The description which follows refers to the terms “weave repeat” and “weave diagram”. A weave repeat is the smallest weave unit whose repetition forms the fabric. A weave diagram is a schematic depiction of the interlacing of horizontal weft threads and vertical warp threads. The crossing points are symbolized by small boxes (squares in the present case). A filled box or square indicates that the warp thread in question is above the particular weft thread and a blank box or square indicates that the warp thread in question is under the particular weft thread. Any one weave diagram can be used to depict either only one repeat, a plurality of whole repeats or one repeat and a plurality of parts of the repeat to indicate how the repeats join up. The figures more particularly described hereinbelow each depict one weave repeat which, however, may also be referred to as a weave diagram.

FIG. 1 illustrates a weave repeat or diagram P1 featuring a single repeat of an illustrative embodiment of the woven fabric G (see FIG. 2) of the traction layer of a drive belt according to this invention. In the weave diagram P1, the columns each represent the warp threads K1-K8 and the rows each represent the weft threads S1-S8.

A weave diagram is always read from the bottom left hand corner (arrow in FIG. 1). Consequently, the warp thread K1 is above the weft thread S1, above the weft thread S2, under the weft threads S3 and S4, above the weft threads S5 and S6, under the weft thread S7 and above the weft thread S8. Two adjacent up or down regions of the warp thread, for example the regions where the warp thread K1 is above the weft threads S5 and S6, are referred to as a (warp) float, since here the warp thread K1 is extended and not immediately deflected again and interlaced by a weft thread. Following the course of the warp thread K1, it is noticed that the 2-thread float where the warp thread K1 is over the weft threads S5 and S6 is followed by a 2-thread float in which the warp thread K1 is under the weft threads S3 and S4 (viewed from the other side of the fabric, the warp thread K1 is there correspondingly over the weft threads S3 and S4). This is followed by a 3-thread float, since the warp thread K1 is over the weft threads S1 and S2 and over the weft thread S8. Since the depicted weave diagram P1 is equal to the repeat, it is subsequently repeated. This results in a 3-thread float which is subsequently interlaced, since the warp thread K1 then passes under the weft thread S7.

The warp thread K2 is consequently under the weft threads S1 and S2, over the weft threads S3 and S4, under the weft thread S5 and over the weft threads S6 to S8. The warp thread K3 is over the weft threads S1 and S2, under the weft thread S3, over the weft threads S4 to S6 and finally again under the weft threads S7 and S8. The warp thread K4 is under the weft thread S1, over the weft threads S2 to S4, under the weft threads S5 and S6 and again over the weft threads S7 and S8.

Considering the course of the warp threads K5 to K8, it is found to be virtually a mirror image of the hitherto described course of the warp threads K1 to K4 about the axis A. In addition, in the reflected half (the right hand side half in FIG. 1), up and down portions of the warp threads have changed places compared with the other (left-hand side) half, a positive/negative inversion as it were. As a result (and this makes the fabric even-sided), the number of warp threads which are down on one side of the fabric is equal to the number of warp threads which are down on the other side of the fabric, and the number of warp threads which are up on one side of the fabric is equal to the number of warp threads which are up on the other side of the fabric.

Consequently, the warp thread K5—when viewed from the same side as the warp threads K1 to K4 (i.e., as depicted in FIG. 1)—passes over the weft thread S1, under the weft threads S2-S4, over the weft threads S5 and S6 and again under the weft threads S7 and S8. The warp thread K6 passes under the weft threads S1 and S2, over the weft thread S3, under the weft threads S4 to S6 and again over the weft threads S7 and S8. The warp thread K7 passes over the weft threads S1 and S2, under the weft threads S3 and S4, over the weft thread S5 and again under the weft threads S6 to S8. The warp thread K8 finally passes under the weft threads S1 and S2, over the weft threads S3 and S4, under the weft threads S5 and S6, over the weft thread S7 and under the weft thread S8.

FIG. 2 depicts a portion of a woven fabric G which belongs to the weave diagram P1 described with reference to FIG. 1. In order that it is plain to see that this is indeed the case, not only the warp threads K1-K8 but also the weft threads S1-S8 are correspondingly designated in FIG. 2.

The weave diagram P1 in FIG. 1 represents a plural-wale twill weave. The evidence for this is as follows: considering first the left side half of the weave diagram, a first wale is formed by the 3-pick groups having the fields K1/S8,S1,S2; K2/S6-S8; K3/S4-S6; K4/S2-S4. With regard to the fields K1/S8,S1,S2 it is to be noted that this weave diagram is equal to the weave repeat (smallest repeatable weave unit) and is consequently repeated in the woven fabric on all sides. Hence the four 3-pick groups mentioned form a first wale in the left half.

There is a second wale in the left half of the weave diagram P1 in FIG. 1. This second wale is formed by the-2-pick groups having the fields K1/S5,S6; K2/S3,S4; K3/S1,S2; K4/S7,S8. It is to be noted that this weave diagram is equal to the weave repeat (smallest repeatable weave unit) and is consequently repeated in the woven fabric on all sides. Hence, the four 2-pick groups mentioned form a second wale in the left half.

With regard to the right hand side half of the weave diagram P1, it is correspondingly possible to make out a third wale and a fourth wale, which, since the right hand side half of the weave diagram is reflected mirror image, extend in the opposite direction.

Correspondingly, the third wale in the right hand side half of the weave diagram P1, which extends on the other side of the fabric, is formed by the 3-pick groups K5/S2-S4; K6/S4-S6; K7/S6-S8; and K8/S8,S1,S2.

The fourth wale is likewise situated in the right hand side half of the weave diagram and is formed by the 2-pick groups K5/S7,S8; K6/S1,S2; K7/S3,S4 and K8/S5,S6.

The two halves of the weave diagram thus each feature two types of wales (a wale comprising 3-pick groups and a wale comprising 2-pick groups), which is why the illustrative embodiment shown constitutes a plural-wale twill weave. A plural-wale twill weave is a twill weave which comprises a plurality of wales within the weave repeat (twill weaves and their wale lines cause the woven fabric to have a diagonal character). In addition, both sides of the fabric have the same construction; there is thus no face or reverse side. The illustrative embodiment described thus constitutes an even-sided plural-wale twill weave.

It will be appreciated that the wales need not be constructed in the manner described; that is, it is not absolutely mandatory for 2-pick and 3-pick groups of twill weaves to form the wales. However, the sides of the fabric have to be constructed such that both sides of the fabric comprise twill weaves which form plural wales and the sides of the fabric have to have the same construction.

Moreover, this fabric can be engineered to interlace with a further woven ply. This can be specifically accomplished such that an even-sided woven fabric will result also after this interlacing with the further woven ply. In this way, the woven fabric having even-sided plural-wale twill weave can be reinforced.

Further, the woven fabric may contain conductive threads, which is advantageous in particular with regard to the fact that drive belts (to ensure driving) and other belts will always generate friction on the surface of a drive element (a metal pulley for example). This can lead to the build-up of electrostatic charge. A spark discharge can then occur where the two rubbing bodies separate, for example where the drive belt loses contact with the pulley. Electrically conductive fibers are effective in preventing this sparking by, for example, transporting the charge to a point where the drive belt touches an electrically grounded structural component or area (on the metal pulley for example), so that the charge can be conducted away without formation of a spark.

The warp threads and the weft threads used may be yarns which can be constructed as continuous filament yarns (monofilaments, multifilaments) or which can also be staple fiber yarns or folded or cabled yarns (folded yarns are two yarns twisted together, cabled yarns are several folded yarns twisted together).

Yarn linear density can vary as a function of the number of threads per centimeter in the range from about 3 tex to about 300 tex not only for the warp threads but also for the weft threads.

The thread count can vary as a function of yarn linear density in the range from about 4 threads/cm to about 4000 threads/cm not only in the warp direction but also in the weft direction. The woven fabric may have the same or else different thread counts in the warp and weft directions.

Possible fiber base materials include not only natural base materials such as, for example, cotton, stalk fibers (e.g., flax, hemp), wool, silk and also ramie etc., but also synthetic base materials such as for example, polyesters, polyamides, polyolefins, aramids, etc., as well as mineral base materials such as, for example glass and carbon etc., and also mixtures thereof.

1. A belt comprising a traction layer comprising a woven fabric (G) comprising an even-sided plural-wale twill weave.

2. A belt according to claim 1, wherein the smallest weave unit (P1) of the woven fabric (G) is constructed according to the following pattern: 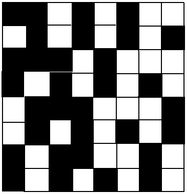
where the columns each represent the warp threads (K1-K8) and the rows each represent the weft threads (S1-S8), a dark field in this pattern denoting that the warp thread (K1-K8) passes over the weft thread (S1-S8) and a light-colored field in this pattern denoting that the warp thread (K1-K8) passes under the weft thread (S1-S8).

3. A belt according to claim 1, wherein the woven fabric (G) of the traction layer, in addition to the woven fabric ply comprising the even-sided plural-wale twill weave, comprises at least one further woven fabric ply which interlaces with the woven fabric ply comprising the even-sided plural-wale twill weave.

4. A belt according to any one of claims 1 to 3, wherein the woven fabric (G) contains conductive threads.

5. A belt according to any of claims 1 to 4, characterized in that it is a drive belt.

6. A belt according to any of claims 1 to 4, characterized in that it is a conveyor belt.

7. A belt according to any of claims 1 to 4, characterized in that it is a process belt.
